(19) United States
(12) Patent Application Publication
(10) Pub. No.: US 2020/0013293 A1
(43) Pub. Date: Jan. 9, 2020

(54) AIRCRAFT HAZARD INFORMATION SYSTEM

(71) Applicant: HONEYWELL INTERNATIONAL INC., Morris Plains, NJ (US)

(72) Inventors: Sanjib Kumar Maji, Bangalore (IN); Elsa Mary Sebastian, Bangalore (IN)

(73) Assignee: HONEYWELL INTERNATIONAL INC., Morris Plains, NJ (US)

(21) Appl. No.: 16/026,515

(22) Filed: Jul. 3, 2018

(51) Int. Cl. G08G 5/00

(52) U.S. Cl. CPC G08G 5/0008; G08G 5/0021

(57) ABSTRACT

Systems and methods of displaying hazard reports to a pilot of a first aircraft by receiving position and trajectory data from a neighbouring aircraft and identifying, using at least one criterion, whether a potential hazard report received from the neighbouring aircraft would indicate a potential hazard for the first aircraft on the basis of the received aircraft positional data and aircraft trajectory data. On the basis of this identification, displaying a representation of a neighbouring aircraft when it is identified that a potential hazard report received from the neighbouring aircraft would indicate a potential hazard for the first aircraft, and causing a receiving module of the first aircraft to begin selectively receiving hazard reports from the neighbouring aircraft.

### TECHNICAL FIELD

The present disclosure generally relates to the field of avionic information systems. More particularly, the present disclosure relates to an avionic information system for receiving hazard reports from off-board locations.

### BACKGROUND

In order to improve in-flight safety and comfort, aircraft pilots may be notified of hazards, such as turbulent weather conditions. For example, when turbulent weather conditions are encountered by a first aircraft, systems such as the Turbulence Auto-PIREP System (TAPS) may be used to disseminate information about the turbulent weather conditions to pilots of other aircraft. In particular, with TAPS, a first aircraft may automatically report encountered turbulent weather conditions and then transmit a hazard report including information about this turbulent weather condition encounter to a ground station. The ground station may then transmit this information to all other aircraft within a certain range of the first aircraft. The other aircraft may then use this information to reduce the likelihood of encountering unexpected turbulence, or to take counter-measures to avoid the turbulent weather conditions in order to reduce the likelihood of crew member and passenger discomfort or injury.

It has been suggested that aircraft-to-aircraft communications (such as by ADS-B Automatic Dependent Surveillance Broadcasts) may also be used for the transmission of hazard reports/pilot reports (PIREPs).

It is desirable to reduce pilot workload in interpreting hazard reports received from ground stations or other aircraft. Furthermore, it is desirable to minimize the bandwidth and processing power necessary for receiving and processing hazard reports.

### BRIEF SUMMARY

This summary is provided to introduce a selection of concepts in a simplified form that are further described below in the detailed description section.

In an exemplary embodiment, there is provided an avionic information system for use in a first aircraft. The avionic information system includes a display module. The information system also includes a receiver module for receiving aircraft positional data and aircraft trajectory data from other aircraft and for selectively receiving hazard reports from neighbouring aircraft. The information system also includes a memory module configured to store at least one criterion for identifying, on the basis of the received aircraft positional data and aircraft trajectory data, whether a potential hazard report received from neighbouring aircraft would indicate a potential hazard for the first aircraft. The information system further includes a processing module operably connected to the display module, to the receiver module and to the memory module. The processing module is configured to determine, using the stored at least one criterion, whether a potential hazard report received from a neighbouring aircraft would indicate a potential hazard for the first aircraft and, when the processing module determines that a potential hazard report received from the neighbouring aircraft would indicate a potential hazard for the first aircraft, the processing module is further configured to cause the display module to display a representation of the neighbouring aircraft and to cause the receiver module to selectively receive hazard reports from the neighbouring aircraft.

In another exemplary embodiment, there is provided a method of displaying hazard reports to a pilot of a first aircraft. The method includes the step of receiving position and trajectory data from a neighbouring aircraft and identifying, using at least one criterion, whether a potential hazard report received from the neighbouring aircraft would indicate a potential hazard for the first aircraft on the basis of the received aircraft positional data and aircraft trajectory data. The method further includes the step of displaying, on a display module, a representation of the neighbouring aircraft when it is identified that a potential hazard report received from the neighbouring aircraft would indicate a potential hazard for the first aircraft. The method further includes the step of causing a receiving module of the first aircraft to begin selectively receiving hazard reports from the neighbouring aircraft.

Other desirable features will become apparent from the following detailed description and the appended claims, taken in conjunction with the accompanying drawings and this background.

### BRIEF DESCRIPTION OF THE DRAWINGS

A more complete understanding of the subject matter may be derived from the following detailed description taken in conjunction with the accompanying drawings, wherein like reference numerals denote like elements, and wherein:

FIG. 1 shows a functional block diagram of an information system in accordance with various embodiments;

FIG. 2 shows an exemplary representation in accordance with various embodiments;

FIG. 3 shows an exemplary symbol key in accordance with various embodiments;

FIG. 4 shows another representation in accordance with various embodiments; and

FIG. 5 shows a flowchart of a method in accordance with various embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the systems and methods defined by the claims. As used herein, the term “module” refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. As used herein, the term “ownship aircraft” refers to an aircraft equipped with an information system in accordance with the various embodiments as described herein, and the term “neighbouring aircraft” refers to other, surroundingaircraft. There is no intention to be bound by any expressed or implied theory presented in the preceding Technical Field, Background, Brief Summary or the following Detailed Description.

For the sake of brevity, conventional techniques and components may not be described in detail herein. Furthermore, any connecting lines shown in the various figures contained herein are intended to represent example functional relationships and/or physical couplings between the various elements. It should be noted that many alternative or additional functional relationships or physical connections may be present in an embodiment of the present disclosure.

It has been recognized by the inventors that displaying to pilots a multitude of hazard reports, such as pilot reports (PIREPs), which are received from multiple neighbouring aircraft, can cause visual confusion for pilots. In particular, in conventional systems, hazard reports which are superfluous for the ownship aircraft are displayed to the pilot of the ownship aircraft, and therefore can visually distract the pilot from the displayed hazard reports that are pertinent to the ownship aircraft. Furthermore, receiving superfluous hazard reports from neighbouring aircraft may unnecessarily increase the graphical processing power and bandwidth required to communicate these hazard reports to the pilot of the ownship aircraft.

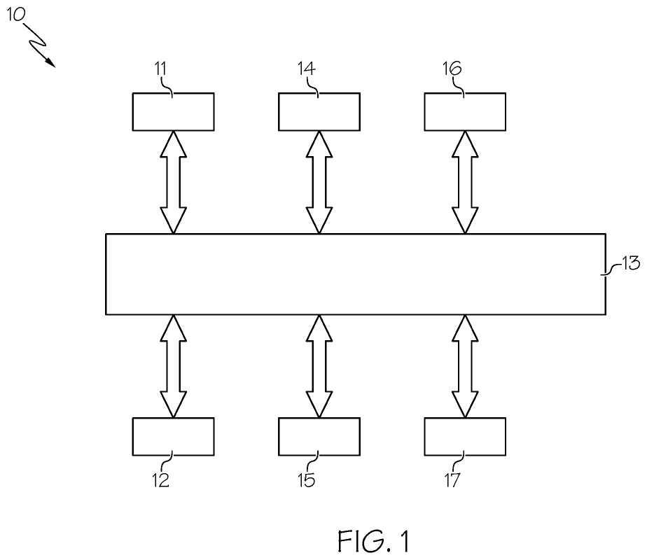

FIG. 1 shows a schematic of an information system 10 for an ownship aircraft in accordance with various embodiments. Arrows in this figure are used to show operable connections between the various elements in this figure. The information system 10 includes a first receiving module 11. The first receiving module 11 is configured to selectively receive information from an off-board location, such as a data transmission from a ground station or a data transmission from a neighbouring aircraft, for example an ADS-B transmission from a neighbouring aircraft. In exemplary embodiments, the first receiving module 11 is configured to selectively receive information from a ground station or from a neighbouring aircraft. In exemplary embodiments, the information selectively received by the first receiving module 11 includes a hazard report, such as a weather hazard report or another type of PIREP report.

In embodiments, the information system 10 further includes a second receiving module 12. The second receiving module is configured to receive information from an off-board location, such as a data transmission from a ground station or a data transmission (such as an ADS-B transmission) from a neighbouring aircraft. In exemplary embodiments, the information received by the second receiving module 12 includes neighbouring aircraft positional and trajectory data.

In an embodiment, the first and second receiving modules 11, 12 are different modules. In an alternative embodiment, the first and second receiving modules 11, 12 form part of one common receiving module, and share common receiver components, with the functions of the first and second receiver modules as described herein both being performed by a sole receiver module.

The information system further comprises a memory module 14. The memory module 14 is configured to store at least one criterion for identifying, on the basis of information received by the second receiving module 12, whether or not a neighbouring aircraft is considered “significant”. As used herein, a “significant” neighbouring aircraft refers to a neighbouring aircraft which has a position and/or trajectory such that, if the neighbouring aircraft were potentially to experience a hazardous weather condition event, the same hazardous weather condition event may be experienced by the ownship aircraft at a future time, when taking into account the intended flight route of the ownship aircraft.

The at least one criterion for determining the significance of a neighbouring aircraft includes one or more conditions related to at least one of positional data related to the neighbouring aircraft and trajectory data related to the neighbouring aircraft. In exemplary embodiments, the at least one criterion is satisfied if one or more conditions selected from the group of following conditions are satisfied:
1. The ownship aircraft is following a similar departure or approach path as the neighbouring aircraft;
2. The ownship aircraft is following the neighbouring aircraft (for example via an In-Trail procedure);
3. The ownship aircraft is coupled to the neighbouring aircraft as part of a “coupled traffic action”;
4. The ownship aircraft has a merging point in common with the neighbouring aircraft;
5. The neighbouring aircraft has previously had a location within a predetermined distance to a future location on the flight path of the ownship aircraft;
6. The neighbouring aircraft has previously had a location within a predetermined distance to a future location on the flight path of the ownship aircraft and has also performed an undeclared maneuver;
7. The ownship aircraft has a heading similar to the neighbouring aircraft and the lateral distance between the ownship aircraft and the neighbouring aircraft is within a pre-determined distance;
8. The ownship aircraft has a non-similar altitude to the neighbouring aircraft and an altitude change is planned for the ownship aircraft to a similar altitude to the neighbouring aircraft.

If the at least one criterion is satisfied by the information received at the second receiving module 12, it is determined that the neighbouring aircraft related to the received information is “significant” to the ownship aircraft.

In particular, the information system 10 includes a processing module 13 operably connected to the first and second receiving modules 11, 12 and the memory module 14. In an embodiment, the processing module 13 is configured to determine, using the stored at least one criterion and the information received from the second receiving module 12, whether a potential hazard report received from a neighbouring aircraft would indicate a potential hazard for the ownship aircraft. In other words, the processing module 13 is configured, on the basis of the stored at least one criterion and the information received at the second receiving module 12, whether the neighbouring aircraft is significant to the ownship aircraft. In an exemplary embodiment, the stored at least one criterion may be updated between flights as new conditions to be included in the at least one criterion are added or developed, or existing conditions included in the stored at least one criterion may be removed.

The information system further includes a display module 15 operably connected to the processing module 13. The display module 15 is configured to display a representation of the locations of significant neighbouring aircraft with respect to the position of the ownship aircraft, as will be explained in more detail below. In an exemplary embodiment, the display module 15 forms part of a primary flight display (PFD) of the ownship aircraft. In an exemplary embodiment, the display module 15 forms part of a multi-function display (MFD).

In an exemplary embodiment, the information system 10 further comprises an input/output (I/O) module 16 operably connected to the processing module 13. The I/O module 16 is configured to allow for the input and output of data to other devices that are operably coupled to the processing module 13. In an exemplary embodiment, the I/O module 16 allows for the connection for pilot input through an input module (not shown), for example a keyboard. In an exemplary embodiment, the I/O module 16 allows for an output to be provided to an output module (not shown), for example a printer.

In an exemplary embodiment, the information system further comprises a transmitter module 17. The transmitter module 17 is configured to transmit requests for further information, for example detailed weather information, from neighbouring aircraft or from a ground station, as will be explained in more detail below.

In use, when the processing module 13 determines that a neighbouring aircraft is significant on the basis of the received neighbouring aircraft position data and neighbouring aircraft trajectory data and using the stored at least one criterion, the processing module 13 causes the display module 15 to display a representation of the location of the significant neighbouring aircraft. The representation of the location of the significant neighbouring aircraft may be a geometric shape, such as a circle, a square or another type of geometric shape, shown together with a distinguishing marker to visually differentiate the significant aircraft from symbols conventionally used to represent all aircraft . In an exemplary embodiment, an irregular triangle is used to represent the location of the significant neighbouring aircraft, and a distinguishing circle marker around the aircraft is used to visually differentiate the symbol used to represent the location of the significant neighbouring aircraft from similar symbols that may have been used to represent non-significant aircraft. The use of an irregular triangle allows for the direction of the neighbouring aircraft's fuselage to be quickly understood by the pilot, with one apex of the irregular triangle representing the nose cone of the significant neighbouring aircraft, and the other apexes of the irregular triangle representing the tail-end of the fuselage of the significant neighbouring aircraft.

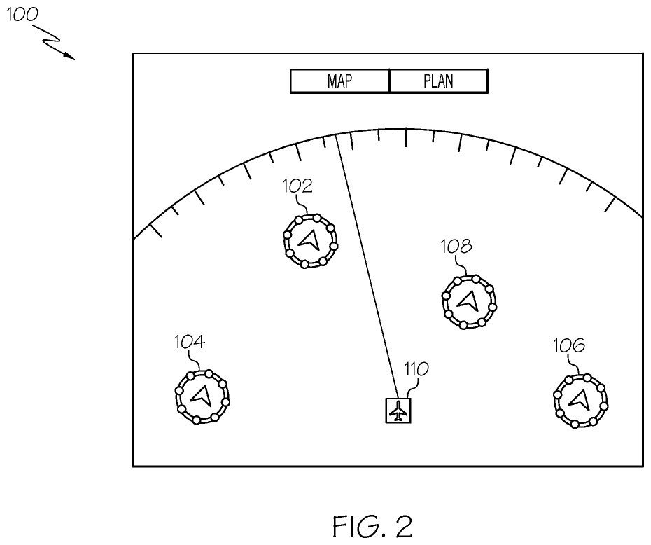

An example representation 100 is shown in FIG. 2. As can be seen in FIG. 2, the processing module 13 has determined, using the at least one criterion and aircraft positional and trajectory data received from surrounding neighbouring aircraft, that four neighbouring aircraft are significant for the ownship aircraft. Indicators 102, 104, 106 and 108 are displayed on the representation, with each one of the indicators 102, 104, 106 and 108 corresponding to a respective significant neighbouring aircraft. In an exemplary embodiment, indicators 102, 104, 106 and 108 are located in a position on the representation 100 representative of their actual position with respect to the ownship aircraft. In an exemplary embodiment, the ownship aircraft's location is represented on the representation 100 through the use of an ownship marker 110, such that the relative positions of the neighbouring aircraft with respect to the ownship aircraft can be easily understood by aircraft crew through a comparison of the indicators 102, 104, 106 and 108 to the ownship marker 110. In the representation shown in FIG. 2, the indicators 102, 104, 106, 108 are displayed as irregular triangles surrounded by a circular symbol, which visually differentiates the irregular triangles in FIG. 2 from irregular triangle symbols that may have previously been used to represent non-significant aircraft. Also in the representation shown in FIG. 2, the planned flight route for the ownship aircraft is shown with a solid line extending from the ownship marker 110.

In an exemplary embodiment, further information may be displayed to the pilot via the display module 15, for example the relative distances between the neighbouring aircraft and the ownship aircraft and/or the intended flight plans of the neighbouring aircrafts. Further additional information that may be presented to the pilot includes terrain data, over which terrain data the indicators 102, 104, 106 and 108 are superimposed. In an exemplary embodiment, any additional information may be displayed or hidden from the representation 100 on the basis of a pilot preference expressed via one or more inputs received at an input of the I/O module 16. The pilot preference may be determined via one or more selectable inputs positioned on the representation 100, such as the exemplary inputs “MAP” and “PLAN” displayed on the representation 100 show in in FIG. 2.

In an exemplary embodiment, when the processing module 13 determines, using the at least one criterion, that a neighbouring aircraft is significant to the ownship aircraft, the processing module 13 causes the first receiving module 11 to start selectively receiving information, such as hazard reports, related to the significant neighbouring aircraft from off-board locations. By selectively receiving information related only to the neighbouring aircraft that are deemed as significant to the ownship aircraft, the amount of bandwidth required to receive these significant hazard reports is reduced, and the amount of processing power required to graphically represent the significant neighbouring aircraft on the representation 100 is also reduced. As such, hazard reports may still be reliably received and processed even in remote locations or with reduced processing power. Furthermore, by receiving only hazard reports from neighbouring aircraft that are displayed on the display module 15, the amount of visual information presented to the pilot is reduced, thereby reducing the workload of the pilot in determining the locations of received hazard reports.

In an exemplary embodiment, the processing module 13 of the ownship aircraft is configured to cause the selective receipt of hazard reports by causing the transmitter module 17 to request the receipt of hazard reports from the significant neighbouring aircraft. In an alternative embodiment, the processing module 13 of the ownship aircraft is not configured to cause the transmitter module 17 to request the receipt of hazard reports related to significant neighbouring aircraft but is instead configured to allow for the first receiving module 11 to selectively receive of hazard reports related to significant neighbouring aircraft, for example by allowing the processing of received transmissions that include header information indicating that the transmission is related to the significant neighbouring aircraft.

In an exemplary embodiment, when a hazard report is received from a significant neighbouring aircraft, a representation of the type of hazard report received is displayed on the display module 15. In an exemplary embodiment, symbology is used to display the severity of the hazard report received from a significant neighbouring aircraft.

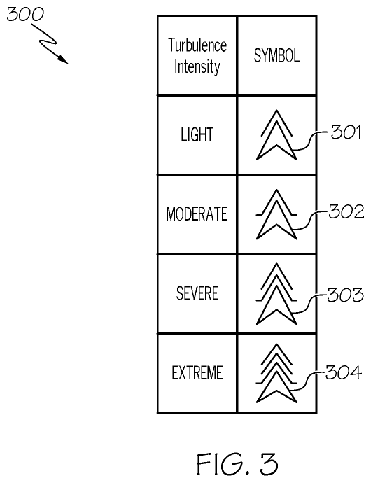

A symbology key 300 showing the symbols used for different types of hazard report is shown in FIG. 3. In the symbology key 300, symbol 301 is used to represent that a neighbouring significant aircraft has issued a hazard report of a “light” severity hazard, for example light turbulence. Symbol 302 is used to represent that a neighbouring significant aircraft has issued a hazard report of a “moderate” severity hazard, for example moderate turbulence. Symbol 303 is used to represent that a neighbouring significant aircraft has issued a hazard report of a “severe” severity hazard, for example severe turbulence. Symbol 304 is used to represent that a neighbouring significant aircraft has issued a hazard report of an “extreme” severity hazard, for example extreme turbulence. In an exemplary embodiment, the hazard report is a weather report. In exemplary embodiments, the classification of which weather conditions are associated with which severity conditions is a pre-determined classification.

In exemplary embodiments, the symbols used to represent the severity of the hazards encountered by neighbouring aircraft may be color-coded for easier identification by the pilot. For example, in an exemplary embodiment, the symbol 301 used to represent “light” severity hazards is green; the symbol 302 used to represent “moderate” severity hazards is yellow; and the symbols 303 and 304 used to represent “severe” and “extreme” severity hazards are red.

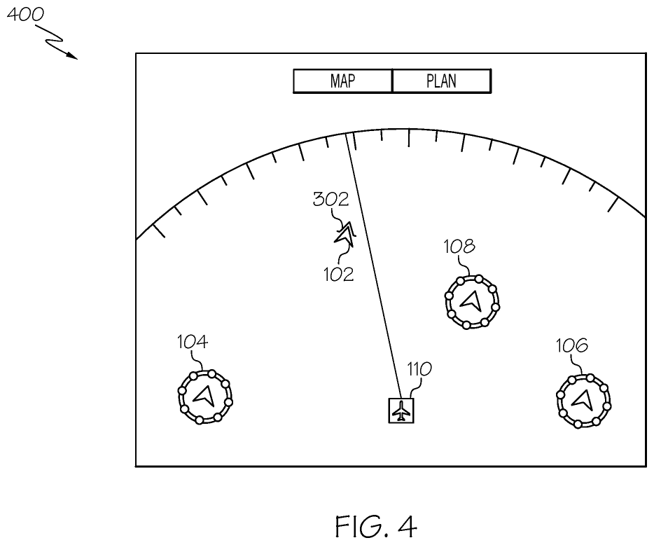

FIG. 4 shows an example representation 400 displayed by the display module 15. In the exemplary representation 400, significant neighbouring aircraft are represented through indicators 102, 104, 106 and 108, and the ownship aircraft is represented through the use of marker 110. In the representation 400, the significant neighbouring aircraft represented by indicator 102 has transmitted a moderate severity hazard report, which is received at the first receiving module 11. The moderate severity hazard report is therefore represented on the indicator 102 via the symbol 302 assigned to denote moderate severity hazard reports. In an exemplary embodiment, the severity of the hazard report issued by the neighbouring aircraft is indicated in a message identifier in the hazard report.

In this manner, the man-machine interface between the pilot and the information system 10 allows for the pilot to quickly and accurately identify hazard reports that may affect the ownship aircraft, without visual confusion and even with reduced processing power available, at reduced bandwidth.

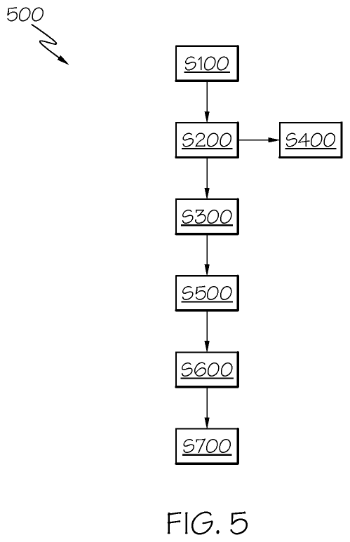

FIG. 5 shows a flowchart detailing a method 500 of representing hazard reports to a pilot.

At step S100, neighbouring aircraft position and trajectory data is received. In an exemplary embodiment, the neighbouring aircraft position and trajectory data is received in the form of traffic information. In an exemplary embodiment, the neighbouring aircraft position and trajectory data includes one or more of the neighbouring aircraft's present position, the neighbouring aircraft's heading, the neighbouring aircraft's velocity and the neighbouring aircraft's intended flight path.

At step S200, the neighbouring aircraft position and trajectory data are analyzed, with a processor, using at least one criterion to determine if the neighbouring aircraft is significant to the ownship aircraft. If multiple sets of aircraft position and trajectory information are received from multiple neighbouring aircraft, each set of received neighbouring aircraft position and trajectory data is analyzed at step S200 and the significance of each one of the neighbouring aircraft to the ownship aircraft is determined using the at least one criterion.

If, at step S200, a neighbouring aircraft is determined by the processor to be significant to the ownship aircraft, the method progresses to step S300. At step S300, a representation is displayed to the pilot showing the location of the significant neighbouring aircraft relative to the ownship aircraft. In an exemplary embodiment, an indicator representative of the significant neighbouring aircraft is displayed relative to a marker representative of the ownship aircraft. In an exemplary embodiment, the position of the indicator relative to the marker is representative of the position of the significant neighbouring aircraft to the ownship aircraft.

If, at step S200, a neighbouring aircraft is determined not to be significant to the ownship aircraft, the method progresses to step S400. At step S400, no representation of the location of that neighbouring aircraft is displayed to the pilot.

After step S300, the method progresses to step S500. At step S500, hazard reports related to significant neighbouring aircraft are selectively received from the significant neighbouring aircraft. In an exemplary embodiment, the hazard reports are received via a transmission from the significant neighbouring aircraft, for example via an ADS-B transmission. Additionally or alternatively, the hazard reports may be received via a transmission from a ground station. In an exemplary embodiment, the hazard reports are weather reports.

In an exemplary embodiment, the ownship aircraft requests, using the transmitter module 17, the receipt of hazard reports from significant neighbouring aircraft. In an alternative embodiment, the ownship aircraft does not request the receipt of hazard reports related to significant neighbouring aircraft but allows for the selective receiving of hazard reports related to significant neighbouring aircraft, for example by allowing the receipt of transmissions at a frequency used for ADS-B transmissions.

After the receipt of at least one hazard report related to a significant neighbouring aircraft, the method progresses to step S600. At step S600, the hazard report is displayed to the pilot. In an exemplary embodiment, the hazard report is displayed to the pilot via a symbol indicating the severity of the hazard report transmitted by the significant neighbouring aircraft.

After step S600, the method progresses to step S700. At step S700, the pilot of the ownship aircraft may optionally request further information related to the received hazard report from the significant neighbouring aircraft or from a ground station using a transmitter module. In an exemplary embodiment, this additional information includes further detail about specific present and/or predicted future hazard conditions, such as adverse weather conditions, in the area of the significant neighbouring aircraft that transmitted the hazard report as determined by a ground weather station. In an exemplary embodiment, this additional information includes informaiton about corrective action taken by the neighbouring aircraft as a result of the hazard experienced by the neighbouring aircraft.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. An avionic information system for use in a first aircraft, the avionic information system comprising:
a display module;
a receiver module for receiving aircraft positional data and aircraft trajectory data from other aircraft, and for selectively receiving weather hazard reports from neighbouring aircraft;
a memory module configured to store at least one criterion for identifying, on the basis of the received aircraft positional data and aircraft trajectory data, whether a potential weather hazard report received from a neighbouring aircraft would indicate a potential weather hazard for the first aircraft; and
a processing module operably connected to the display module, to the receiver module and to the memory module, wherein the processing module is configured to determine, using the stored at least one criterion, whether a potential weather hazard report received from a neighbouring aircraft would indicate a potential weather hazard for the first aircraft and, when the processing module determines that a potential weather hazard report received from the neighbouring aircraft would indicate a potential weather hazard for the first aircraft, the processing module is further configured to cause the display module to display a representation of the neighbouring aircraft and to cause the receiver module to selectively receive weather hazard reports from the neighbouring aircraft.

2. (canceled)

3. The avionic information system of claim 1, wherein, when the receiver module receives a weather hazard report from the neighbouring aircraft, the processing module is configured to cause the display module to display a symbol associated with the representation of the neighbouring aircraft.

4. The avionic information system of claim 3, wherein a shape of the symbol is related to a severity classification of the received weather hazard report.

5. The avionic information system of claim 1, wherein the information system further comprises a transmitter module configured to transmit a request for weather hazard reports to the neighbouring aircraft.

6. The avionic information system of claim 5, wherein the transmitter module is further configured to transmit a request for further information about a received weather hazard report to a ground station, and wherein the receiver module is configured to receive the requested further information from the ground station.

7. The avionic information system of claim 1, wherein the at least one criterion includes a condition selected from the group of: determining if the first aircraft is following a similar departure or approach path to the neighbouring aircraft; determining if the first aircraft is following a flight path similar to the flight path of the neighbouring aircraft; determining if the first aircraft is coupled to the neighbouring aircraft; determining if the first aircraft has a merging point in common with the neighbouring aircraft; determining if the neighbouring aircraft was previously positioned at a location within a predetermined distance to a future location on a planned flight path of the first aircraft; determining if the neighbouring aircraft has previously had a location within a predetermined distance to a future location on the flight path of the first aircraft and has also performed an undeclared maneuver; determining if the first aircraft has a heading similar to the neighbouring aircraft and the lateral distance between the first aircraft and the neighbouring aircraft is within a pre-determined distance; and determining if the first aircraft has a non-similar altitude to the neighbouring aircraft and an altitude change is planned for the first aircraft to a similar altitude as the neighbouring aircraft.

8. A method of displaying hazard reports to a pilot of a first aircraft, the method comprising:
receiving position and trajectory data from a neighbouring aircraft;
identifying, using at least one criterion, whether a potential weather hazard report received from the neighbouring aircraft would indicate a potential weather hazard for the first aircraft on the basis of the received aircraft positional data and aircraft trajectory data;
displaying, on a display module, a representation of the neighbouring aircraft when it is identified that a potential weather hazard report received from the neighbouring aircraft would indicate a potential weather hazard for the first aircraft; and
causing a receiving module of the first aircraft to begin selectively receiving weather hazard reports from the neighbouring aircraft.

9. The method of claim 8, wherein the step of causing the receiving module of the first aircraft to begin selectively receiving weather hazard reports from the neighbouring aircraft comprises transmitting, using a transmitter module, a request to the neighbouring aircraft for weather hazard reports.

10. The method of claim 8, wherein the step of causing the receiving module of the first aircraft to begin selectively receiving weather hazard reports from the neighbouring aircraft comprises allowing the receiving of weather hazard reports containing header information associated with the neighbouring aircraft.

11. (canceled)

12. The method of claim 8, further comprising the step of, when the receiver module receives a weather hazard report from the neighbouring aircraft, displaying a symbol associated with the weather hazard report on the display module.

13. The method of claim 12, wherein a shape of the symbol is related to a severity classification of the received weather hazard report.

14. The method of claim 8, further comprising transmitting a request for further information about a received weather hazard report to a ground station.

15. The method of claim 8, wherein the at least one criterion includes a condition selected from the group of: determining if the first aircraft is following a similar departure or approach path to the neighbouring aircraft; determining if the first aircraft is following a flight path similar to the flight path of the neighbouring aircraft; determining if the first aircraft is coupled to the neighbouring aircraft; determining if the first aircraft has a merging point in common with the neighbouring aircraft; determining if the neighbouring aircraft was previously positioned at a location within a predetermined distance to a future location on a planned flight path of the first aircraft; determining if the neighbouring aircraft has previously had a location within a predetermined distance to a future location on the flight path of the first aircraft and has also performed an undeclared maneuver; determining if the first aircraft has a heading similar to the neighbouring aircraft and the lateral distance between the first aircraft and the neighbouring aircraft is within a pre-determined distance; and determining if the first aircraft has a non-similar altitude to the neighbouring aircraft and an altitude change is planned for the first aircraft to a similar altitude as the neighbouring aircraft.

16. An avionic information system for use in a first aircraft, the avionic information system comprising:
a display module;
a receiver module for receiving aircraft positional data and aircraft trajectory data from other aircraft, and for selectively receiving hazard reports from neighbouring aircraft;
a memory module configured to store at least one criterion for identifying, on the basis of the received aircraft positional data and aircraft trajectory data, whether a potential weather hazard report received from a neighbouring aircraft would indicate a potential weather hazard for the first aircraft; and
a processing module operably connected to the display module, to the receiver module and to the memory module, wherein the processing module is configured to determine, using the stored at least one criterion, whether a potential weather hazard report received from a neighbouring aircraft would indicate a potential weather hazard for the first aircraft and, when the processing module determines that a potential weather hazard report received from the neighbouring aircraft would indicate a potential weather hazard for the first aircraft, the processing module is further configured to cause the display module to display a representation of the neighbouring aircraft and to cause the receiver module to selectively receive weather hazard reports from the neighbouring aircraft; and wherein the information system further comprises a transmitter module configured to transmit a request for weather hazard reports to the neighbouring aircraft so as to selectively receive weather hazard reports from the neighbouring aircraft.
